(19) United States
(12) Patent Application Publication
(10) Pub. No.: US 2020/0133267 A1
(43) Pub. Date: Apr. 30, 2020

(54) MIDDLEWARE SUPPORT FOR FAULT-TOLERANT EXECUTION IN AN ADAPTIVE PLATFORM FOR A VEHICLE

(71) Applicant: GM Global Technology Operations LLC, Detroit, MI (US)

(72) Inventors: Anand Ganpat Bhat, Pittsburgh, PA (US); Soheil Samii, Troy, MI (US)

(73) Assignee: GM Global Technology Operations LLC, Detroit, MI (US)

(21) Appl. No.: 16/170,104

(22) Filed: Oct. 25, 2018

(51) Int. Cl. G05D 1/00; H04L 29/08; B60W 50/029; B60W 50/14

(52) U.S. Cl. CPC G05D 1/0077; G05D 1/0022; H04L 67/125; B60W 2050/143; B60W 50/14; G05D 2201/0213; B60W 2050/0292; B60W 50/029

(57) ABSTRACT

A method for controlling a vehicle includes: establishing, by a vehicle controller, a connection between a client and a plurality of servers, the plurality of servers includes a primary server and at least one replica server, the at least one replica server is a replica of the primary server; making, by the vehicle controller, a data request about a given service to the plurality of servers; in response to the data request, receiving reply data from the plurality of servers to the data request via a middleware; fusing, by the middleware, the reply data from the plurality of servers to generate a resulting data; receiving, by the vehicle controller, the resulting data; and controlling, by the client, the vehicle based on the resulting data.

### INTRODUCTION

The present disclosure relates to a fault-tolerant execution in a middleware adaptive platform for a vehicle.

Current production motor vehicles, such as the modern-day automobile, are originally equipped with a powertrain that operates to propel the vehicle and power the vehicle's onboard electronics. In automotive applications, for example, the vehicle powertrain is generally typified by a prime mover that delivers driving power to the vehicle's road wheels through a manually or automatically shifted multi-speed transmission and a final drive system (e.g., differential, axle shafts, etc.). Automobiles have historically been powered by a reciprocating-piston type internal combustion engine (ICE) assembly due to its ready availability and relatively inexpensive cost, light weight, and overall efficiency. Such engines include two and four-stroke compression-ignited (CI) diesel engines, four-stroke spark-ignited (SI) gasoline engines, six-stroke architectures, and rotary engines, as some non-limiting examples. Hybrid and full electric vehicles, on the other hand, utilize alternative power sources to propel the vehicle and, thus, minimize or eliminate reliance on a fossil-fuel based engine for power.

Hybrid vehicle powertrains utilize multiple sources of traction power to propel the vehicle, most commonly operating an internal combustion engine assembly in conjunction with a battery-powered or fuel-cell-powered electric motor. A hybrid electric vehicle (HEV), for example, stores both electrical energy and chemical energy, and converts the same into mechanical power to drive the vehicle's road wheels. The HEV is generally equipped with an electric machine (E-machine), often in the form of a motor/generator unit (MGU), that operates in parallel or in series with an ICE. Series hybrid architectures derive all tractive power from electric motor(s) and, thus, eliminate any driving mechanical connection between the engine and final drive members. By comparison, the engine and motor/generator assemblies of parallel hybrid architectures each have a driving mechanical coupling to the power transmission. Since hybrid vehicles are designed to derive their power from sources other than the ICE, engines in HEVs may be turned off, in whole or in part, while the vehicle is propelled by the electric motor(s).

A full electric vehicle (FEV)—colloquially known as an “electric car”—is an alternative type of electric-drive vehicle configuration that altogether eliminates the internal combustion engine and attendant peripheral components from the powertrain system, relying solely on electric traction motors for vehicle propulsion. Battery electric vehicles (BEV), for example, utilize energy stored within a rechargeable, onboard battery pack, rather than a fuel tank, fuel cell, or fly-wheel, to power the electric motor(s). The electric vehicle employs an electrical power distribution system governed via a powertrain control module (PCM) for transmitting electrical energy back-and-forth between the onboard battery pack and the electric motor(s). Plug-in electric vehicle (PEV) variants allow the battery pack to be recharged from an external source of electricity, such as a public power grid, via a residential or commercial vehicle charging station.

As vehicle processing, communication, and sensing capabilities continue to improve, manufacturers persist in offering more system-automated driving capabilities with the aspiration of eventually offering fully autonomous vehicles competent to operate among heterogeneous vehicle types in both urban and rural scenarios. Original equipment manufacturers (OEM) are moving towards vehicle-to-vehicle (V2V) and vehicle-to-infrastructure (V2I) “talking” cars, integrating wireless connectivity (e.g., Dedicated Short Range Communications or DSRC) with higher-level driving automation features that employ autonomous steering, braking, and powertrain systems to enable driverless vehicle operation. Automated route generation systems utilize vehicle state and dynamics sensors, roadway map data, and path prediction algorithms to provide vehicle routing and rerouting with automated lane center and lane change forecasting, scenario planning, etc. For purposes of this disclosure, “automated vehicles” and “autonomous vehicles” and “connected automated/autonomous vehicles” (CAVs) may be used synonymously and interchangeably to denote vehicles with partially assisted and/or fully autonomous driving capabilities, including any relevant vehicle platform that may be classified as a Society of Automotive Engineers (SAE) Level 2, 3, 4 or 5 vehicles.

Many automobiles are now equipped with an onboard vehicle navigation system that utilizes a global positioning system (GPS) transceiver in cooperation with navigation software and a mapping database to obtain roadway topography, traffic and speed limit information associated with the vehicle's current location. Advanced driver assistance systems (ADAS) and autonomous driving systems are often able to adapt certain automated driving maneuvers based on roadway information obtained by the in-vehicle navigation system. Ad-hoc-network-based ADAS, for example, employ GPS and mapping data in conjunction with multi-hop geocast V2V and V2I data exchanges to facilitate automated vehicle maneuvering and powertrain control. During assisted and unassisted vehicle operation, the resident navigation system may determine a recommended travel route based on an estimated shortest time or estimated shortest distance between a route origin and a route destination for a given trip. This recommended travel route may then be displayed as a map trace or as turn-by-turn driving directions on a geocoded and annotated map. Such approaches to route planning, while effective at determining the shortest travel distance/time to a desired destination, do not account for the most energy efficient routes or the most favorable routes for governing vehicle operation.

### SUMMARY

The present disclosure describes a method for controlling the vehicle with a middleware. The method allows cost-effective replication while maintaining end-to-end guarantees and support different replication strategies. For example, the method provides cost saving in terms of computation and communication bandwidth resources in comparison with traditional active replication techniques. Application programmers may write applications agnostic of the replication considerations.

In one example, the method includes: establishing, by the vehicle controller, a connection between a client and a plurality of servers, the plurality of servers includes a primary server and at least one replica server, the at least one replica server is a replica of the primary server; making, by the vehicle controller, a data request about a given service to the plurality of servers; in response to the data request, receiving reply data from the plurality of servers to the data request via a middleware; fusing, by the middleware, the reply data from the plurality of servers to generate a resulting data; receiving, by the vehicle controller, the resulting data; and controlling, by the vehicle controller, the vehicle based on the resulting data. The method also supports a plurality of clients, the plurality of clients include a primary client and at least one replica client, connecting to a single server and in the more general case a plurality of clients connecting to a plurality of servers. A single application can act as both a client and as a server as well.

The method may further include generating a plurality of notifications by the plurality of servers in response to establishing the connection between the client and the plurality of servers; and filtering, by the middleware, duplicate notifications from the plurality of notifications generated by the plurality of servers to generate a filtered notification. The method may further include receiving, by the client, the filtered notification; and registering, by the plurality of servers, a same service of a plurality of services with the middleware. The method may further include maintaining, by the middleware, a list of instances for the same service of the plurality of services. In the case of a plurality of clients and a single server the method may also include filtering of duplicate requests by the middleware.

The method may further include providing, by the client, a fusion strategy to the plurality of servers; and providing, by the vehicle controller, a filter strategy to the plurality of servers. The method may further include activating, by the vehicle controller, an alarm in response to receiving the filtered notification from the middleware.

The present disclosure also describes a system including a vehicle having a vehicle body and a vehicle controller attached to the vehicle body. The vehicle controller is programmed with at least one client and a plurality of servers. The plurality of servers includes a primary server and at least one replica server, and the at least one replica server is a replica of the primary server. The client is in communication with the plurality of servers. The client invokes the middleware to establish a connection between the client and the plurality of servers. The vehicle controller is programmed to execute the method described above.

The above features and advantages and other features and advantages of the present teachings are readily apparent from the following detailed description of the best modes for carrying out the teachings when taken in connection with the accompanying drawings.

### BRIEF DESCRIPTION OF THE DRAWINGS

FIG. 1 is a schematic illustration of a representative motor vehicle with a network of controllers, sensing devices, and communication devices for executing eco-routing techniques and automated driving operations in accordance with aspects of the present disclosure.

FIG. 2 is a schematic illustration of a hardware architecture of a system for establishing communication among a primary server, at least one replica primary server, and a client, wherein the client is a vehicle controller.

FIG. 3 is a schematic diagram of a software architecture of the system shown in FIG. 2.

FIG. 4 is a flowchart of a method for controlling the vehicle.

### DETAILED DESCRIPTION

This disclosure is susceptible of embodiment in many different forms. Representative embodiments of the disclosure are shown in the drawings and will herein be described in detail with the understanding that these representative examples are provided as an exemplification of the disclosed principles, not limitations of the broad aspects of the disclosure. To that extent, elements and limitations that are described, for example, in the Abstract, Introduction, Summary, and Detailed Description sections, but not explicitly set forth in the claims, should not be incorporated into the claims, singly or collectively, by implication, inference or otherwise.

For purposes of the present detailed description, unless specifically disclaimed: the singular includes the plural and vice versa; the words “and” and “or” shall be both conjunctive and disjunctive; the words “any” and “all” shall both mean “any and all”; and the words “including,” “containing,” “comprising,” “having,” and the like, shall each mean “including without limitation.” Moreover, words of approximation, such as “about,” “almost,” “substantially,” “approximately,” and the like, may be used herein in the sense of “at, near, or nearly at,” or “within 0-5% of,” or “within acceptable manufacturing tolerances,” or any logical combination thereof, for example. Lastly, directional adjectives and adverbs, such as fore, aft, inboard, outboard, starboard, port, vertical, horizontal, upward, downward, front, back, left, right, etc., may be with respect to a motor vehicle, such as a forward driving direction of a motor vehicle when the vehicle is operatively oriented on a normal driving surface.

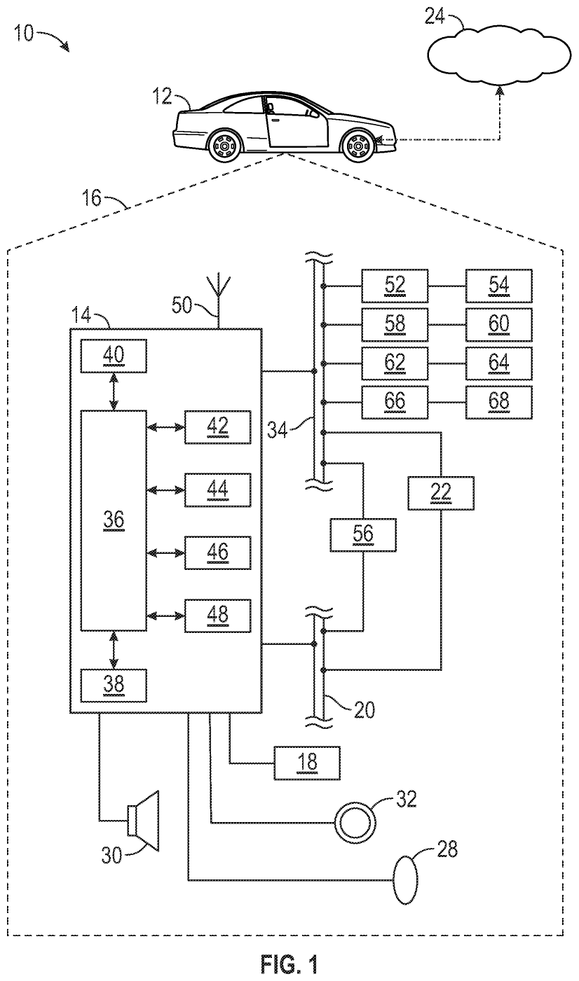

Referring now to the drawings, wherein like reference numbers refer to like features throughout the several views, FIG. 1 shows a representative vehicle, which is designated generally at 10 and portrayed herein for purposes of discussion as a sedan-style passenger vehicle. Packaged on a vehicle body 12 of the vehicle 10, e.g., distributed throughout the different vehicle compartments, is an onboard network of electronic devices for executing one or more assisted or automated driving operations. The illustrated vehicle 10—also referred to herein as “motor vehicle” or “automobile” for short—is merely an exemplary application with which aspects and features of this disclosure may be practiced. In the same vein, implementation of the present concepts for the specific computing network architecture discussed below should also be appreciated as an exemplary application of the novel features disclosed herein. As such, it will be understood that aspects and features of this disclosure may be applied to other system architectures, utilized for various automated driving operations, and implemented for a logically relevant type of motor vehicle. Moreover, solely select components of the network and vehicle have been shown and will be described in additional detail below. Nevertheless, the motor vehicles and network architectures discussed herein may include numerous additional and alternative features, and other available peripheral components, for example, to carry out the various methods and functions of this disclosure. Lastly, the drawings presented herein are not necessarily to scale and are provided purely for instructional purposes. Thus, the specific and relative dimensions shown in the drawings are not to be construed as limiting.

The representative vehicle 10 of FIG. 1 is originally equipped with a vehicle telecommunication and information (“telematics”) unit 14 that wirelessly communicates (e.g., via cell towers, base stations, V2X, and/or mobile switching centers (MSCs), etc.) with a communications network 24. The communications network 24 may be a cellular network and/or a satellite network. Some of the other vehicle hardware components 16 shown generally in FIG. 1 include, as non-limiting examples, an electronic video display device 18, a microphone 28, one or more audio speakers 30, and assorted input controls 32 (e.g., buttons, knobs, switches, trackpads, keyboards, touchscreens, etc.). Generally, these hardware components 16 function, at least in part, as a resident vehicle navigation system, e.g., to enable assisted and/or automated vehicle navigation, and as a human/machine interface (HMI), e.g., to enable a user to communicate with the telematics unit 14 and other systems and system components of the vehicle 10. A microphone 28 provides a vehicle occupant with means to input verbal or other auditory commands; the vehicle 10 may be equipped with an embedded voice-processing unit programmed with a computational speech recognition software module. Conversely, a speaker 30 provides audible output to a vehicle occupant and may be either a stand-alone speaker dedicated for use with the telematics unit 14 or may be part of audio system 22. The audio system 22 is operatively connected to a network connection interface 34 and an audio bus 20 to receive analog information, rendering it as sound, via one or more speaker components.

Communicatively coupled to the telematics unit 14 is a network connection interface 34, suitable examples of which include twisted pair/fiber optic Ethernet switch, internal/external parallel/serial communication bus, a local area network (LAN) interface, a controller area network (CAN), a media-oriented system transfer (MOST), a local interconnection network (LIN) interface, and the like. Other appropriate communication interfaces may include those that conform with ISO, SAE, and IEEE standards and specifications. The network connection interface 34 enables the vehicle hardware 16 to send and receive signals with each other and with various systems and subsystems both within or “resident” to the vehicle body 12 and outside or “remote” from the vehicle body 12. This allows the vehicle 10 to perform various vehicle functions, such as controlling vehicle steering, governing operation of the vehicle's transmission, controlling engine throttle, engaging/disengaging the brake system, and other automated driving functions. For instance, telematics unit 14 receives and/or transmits data to/from an ADAS electronic control unit (ECU) 52, an engine control module (ECM) 54, a powertrain control module (PCM) 56, sensor interface module(s) 58, a brake system control module (BSCM) 60, and assorted other vehicle ECUs, such as a transmission control module (TCM), a climate control module (CCM), etc.

With continuing reference to FIG. 1, telematics unit 14 is an onboard computing device that provides a mixture of services, both individually and through its communication with other networked devices. This telematics unit 14 is generally composed of one or more processors 40, each of which may be embodied as a discrete microprocessor, an application specific integrated circuit (ASIC), a dedicated control module, etc. The vehicle 10 may offer centralized vehicle control via a central processing unit (CPU) or vehicle controller 36 that is operatively coupled to one or more electronic memory devices 38, each of which may take on the form of a CD-ROM, magnetic disk, IC device, semiconductor memory (e.g., various types of RAM or ROM), etc., and a real-time clock (RTC) 42. Long-range vehicle communication capabilities with remote, off-board networked devices may be provided via one or more of a cellular chipset/component, a navigation and location chipset/component (e.g., global positioning system (GPS) transceiver), or a wireless modem, which are collectively represented at 44. Close-range wireless connectivity may be provided via a short-range wireless communication device 46 (e.g., a BLUETOOTH® unit or near field communications (NFC) transceiver), a dedicated short-range communications (DSRC) component 48, and/or a dual antenna 50. It should be understood that the vehicle 10 may be implemented without one or more of the above listed components, or may include additional components and functionality as desired for a particular end use. The various communications devices described above may be configured to exchange data as part of a periodic broadcast in a V2V communication system or other vehicle-to-everything (V2X) communication system, e.g., Vehicle-to-Infrastructure (V2I), Vehicle-to-Pedestrian (V2P), and/or Vehicle-to-Device (V2D).

The vehicle controller 36 receives sensor data from one or more sensing devices that use, for example, photo detection, radar, laser, ultrasonic, optical, infrared, or other suitable technology for executing an automated driving operation. In accord with the illustrated example, the vehicle 10 may be equipped with one or more digital cameras 62, one or more range sensors 64, one or more vehicle speed sensors 66, one or more vehicle dynamics sensors 68, and a requisite filtering, classification, fusion and analysis hardware and software for processing raw sensor data. A digital camera 62 may use a charge coupled device (CCD) sensor or other suitable optical sensor to generate images indicating a field-of-view of the vehicle 10, and may be configured for continuous image generation, e.g., at least about 35 images generated per second. By way of comparison, range sensor 64 may emit and detect reflected radio, electromagnetic, or light-based waves (e.g., radar, EM inductive, Light Detection and Ranging (LIDAR), etc.) to detect, for example, presence, geometric dimensions, and/or proximity of an object. Vehicle speed sensor 66 may take on various forms, including wheel speed sensors that measure wheel speeds, which are then used to determine real-time vehicle speed. In addition, the vehicle dynamics sensor 68 may be in the nature of a single-axis or a triple-axis accelerometer, an angular rate sensor, an inclinometer, etc., for detecting longitudinal and lateral acceleration, yaw, roll, and/or pitch rates, or other dynamics related parameter. Using data from the sensing devices 62, 64, 66, 68, the vehicle controller 36 identifies objects within a detectable range of the vehicle 10, and determines attributes of the target object, such as size, relative position, angle of approach, relative speed, etc.

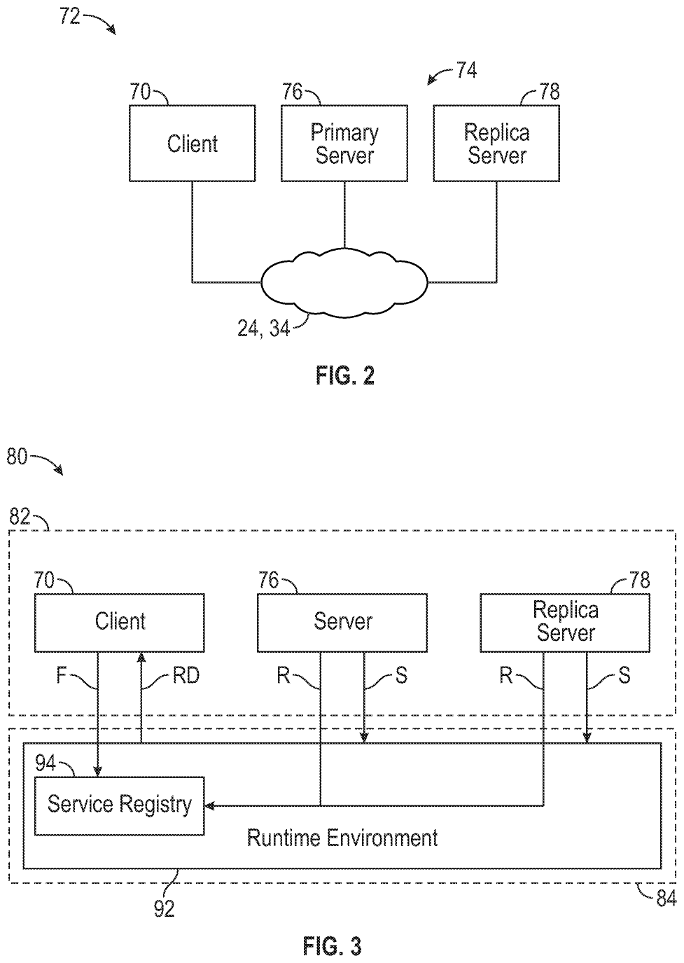

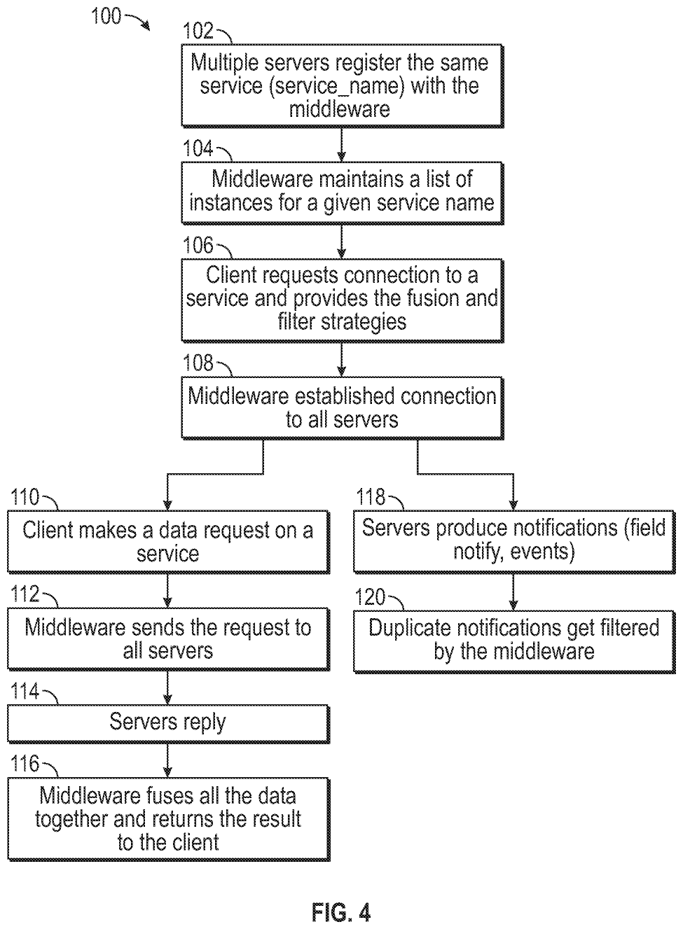

With reference to FIG. 2, in this disclosure, a system 72 includes one or more clients 70 and a plurality of servers 74 each in communication with the client 70 through the communications network 34 and/or 24. In the present disclosure, the vehicle controller 36 is considered a client 70. As used herein, the term “client” means a software that is capable of obtaining information and applications from a server. Thus, the client 70 (which may run on the vehicle controller 36) is capable of obtaining information and applications from the plurality of servers 74. The term “server” means a software application that manages access to a centralized resource or service in a network. Thus, each of the servers 74 manages access to a centralized resource or a service through the communications network 34 and/or 24. The services provided by the servers 74 may include, but are not limited to, crypto service, diagnostics, security management, software configuration, autonomous driving services and V2X services, etc. The servers 74 should create data that is compatible with the requirements of the client 70.

The plurality of servers 74 includes a primary server 76 and at least one replica server 78. The primary server 76 may be running on a physical computing device including a processor to process requests from and deliver data to the client 70 over the communications network 34 and/or 24. Thus, the primary server 76 is in communication with the client 70 (which may run on the vehicle controller 36) through the communications network 34 and/or 24. The replica server 78 is a replica of the primary server 76 and may be running on a physical computing device including a processor to process requests from and deliver data to the client 70 over the communications network 24. Alternatively or additionally, the replica server 78 may be running on a virtual machine. As used herein, the term “replica server” means a server that includes the same software (e.g., applications and services) and data as the primary server 76 to provide fault-tolerance to the system 72. In the present disclosure, the term “fault-tolerance” means a property that enables the system 72 to continue operating properly in the event of the failure of some (or one or more faults within) of its components. For example, because of the replica server 78, the system 72 is capable of continuous operation even if the primary server 76 fails. While FIG. 2 shows solely one replica server 78, it is contemplated that the system 72 may include more than one replica servers 78 to enhance its fault-tolerance. The replica server 78 is programmed to preform one or more types of software replication, such as active clone, hot standby, warm standby, cold standby, and/or frigid standby. For example, when functioning as an active clone, the replica server 78 receives inputs from the client 70 (which may run on the vehicle controller 36) at different times than the primary server 76 and the freshest data (i.e., later in time inputs) may be used. It is envisioned that the system 72 may conduct passive replication (instead of active replication). In the passive replication, the replica server 78 subscribes to the primary server 76 and receives state and health information of the primary server 76. The client 70 may be programmed to obtain the freshest data (i.e., the data with the latest timestamp) from the servers 74. The primary server 76 and the replica server 78 may receive data about the current location (determined using the GPS transceiver) of the vehicle 10 at different times. By having at least one replica server 78, the client 70 (which may run on the vehicle controller 36) may still obtain information and applications from one of the replica servers 78 if the primary server 76 fails. By the same token, the client 70 may still receive information and applications from the primary server 76 if one of the replica servers 78 fails. The replica server(s) 78 provide replicating services (i.e., implicit multiple instantiation by starting/running the same executable application multiple times). Each of the replica servers 78 is identical to the primary server 76 The replica server 78 may have two distinct executables providing the same service.

With reference to FIG. 3, the system 72 may have a software architecture 80 for executing the appropriate functionality of the vehicle 10 and may be referred to as a distributed system. The software architecture 80 includes an application layer 82 and a middleware layer 84. In the present disclosure, the term “middleware” means a computer software that provides services to software applications beyond those available from the operating system. The application layer 82 includes a primary server 76, at least one server replica 78, and a client 70. As discussed above, the system 72 may include more than one replica server 78. The middleware layer 84 may be simply referred to as the middleware and acts as a bridge between: (1) a client 70 and (2) server 76 and the server replica 78. The middleware layer 84 includes a runtime environment for managing communications between: (1) the client 70 and (2) and the server 76 and the server replica 78. For example, the middleware layer 84 may be AUTOSAR™ or another suitable middleware. The middleware layer 84 further includes a service registry 94. In the present disclosure, the term “service registry” means a database of services, their instances and their locations. Thus, the service registry 94 is, among other things, a database populated with information on how to dispatch requests to service instances. In this software architecture 80, the server 76 and the server replica 78 registers a service (including the service name and its corresponding data format) with the middleware layer 84 (as indicated by arrows R). Each of the server 76 and the one or more server replicas 78 registers the same service (having the same service name and data format) with the service registry 94 of the middleware layer 84. The middleware layer 84 may include software to maintain a vector of active proxies (i.e., handles), which are basically connection objects with different server instances. The client 70 finds the service (by its service name and in accordance with a fusion strategy) on the middleware layer 84 (as indicated by arrow F). For example, the client 70 invokes an application programming interface (API) call on the middleware to start looking for available services. The client 70 may register a callback for service registry update. In response, the middleware layer 84 updates the service registry based on a registry update event. The middleware layer 84 may also initiate a dynamic service discovery in response to the callback for a service registry update. Each of the server 76 and the server replica(s) 78 sends reply data to the middleware layer 84 as indicated by arrows S in response to a data request from the client 70. The middleware layer 84 executes a fusion strategy to fuse the reply data received from the server 76 and the server replica(s) 78 to obtain a resulting data. To fuse the reply data received from the servers 74, the client 70 is programmed with a fusion strategy, such as determining the average, mean, and/or median (among others) of the data obtained from the primary server 76 and the replica server(s) 78. The client 70 may also be programmed with subscription/un-subscription methods and a data validation function. The middleware layer 84 then sends the resulting data from the fusion strategy to the client 70 (as indicated by arrow RD) to execute the appropriate function. The data sent by the servers 74 through the middleware layer 84 may include time stamps, server details (e.g., replica type, service quality, etc.), sequence numbers, etc.

FIG. 3 is a flowchart that illustrates a method for controlling the vehicle 10 with the middleware layer 92. As discussed above, the middleware layer 92 may be simply referred to as the middleware. The method 100 allows cost-effective replication while maintaining end-to-end guarantees and support different replication strategies. For example, the method 100 provides cost saving in terms of computation and communication bandwidth resources in comparison with traditional active replication techniques and may be executed by the vehicle controller 36. Further, the method 100 is independent of the location of the service. Application programmers may write applications agnostic of the replication considerations. The method 100 begins at block 102, in which each of the primary server 76 and the replica server(s) 78 registers a service under the same service name with the service registry 94 of the middleware layer 92. Actually, at block 102, each of the primary server 76 and the replica server(s) 78 registers multiple services (each service under the same respective service name) with the service registry 94 of the middleware layer 92. Then, the method 100 proceeds to block 104. At block 104, the middleware layer 92 maintains a list of instances for a given service name out of a plurality of services. Then, the method 100 proceeds to block 106.

At block 106, the client 70 requests the connection to a service from the middleware layer 84. Next, the method proceeds to block 108. At block 108, the middleware layer 84 establishes a connection between the client 70 and the plurality of servers 74. Then, the method 100 proceeds to block 110. At block 110, the client 70 makes a data request about a given service to the plurality of servers using a remote procedure call (RPC). This data request includes the field/get set data on a given service. Then, the method 100 proceeds to block 112. At block 112, the middleware layer 84 sends the data request from the client 70 to all of the plurality of servers 74 (including the primary server 76 and the replica server(s) 78) in response to the data request from the client 70. Then, the method 100 proceeds to block 114. At block 114, the plurality of servers 74 reply with reply data to the data request from the client 70 (sent through the middleware layer 84). Next, the method 100 proceeds to block 116. At block 116, the middleware layer 84 fuses all of the reply data from the plurality of servers 74 to generate a resulting data. This resulting data is then sent to the client 70. Also at block 116, the vehicle controller 36 controls the vehicle 10 based on the resulting data.

After block 108, the method 100 also proceeds to block 118. At block 118, the plurality of servers 74 produce notifications (including field notify data and events data). Then, the method 100 proceeds to block 120. At block 120, the middleware layer 84 filters the duplicate notifications produced by the plurality of servers 74 to generate a filtered notification. The filter function of the middleware layer 84 may be based on timestamps and sequence numbers of the data (i.e., the filter strategy). Also at block 120, the client 70 receives the filtered notification. Also at block 120, the client 79 activates an alarm (through the video display device 18 and/or the audio speakers 30) in response to receiving the filtered notification from the middleware layer 84.

While the best modes for carrying out the teachings have been described in detail, those familiar with the art to which this disclosure relates will recognize various alternative designs and embodiments for practicing the teachings within the scope of the appended claims. The system 74 illustratively disclosed herein may be suitably practiced in the absence of any element which is not specifically disclosed herein. Furthermore, the embodiments shown in the drawings or the characteristics of various embodiments mentioned in the present description are not necessarily to be understood as embodiments independent of each other. Rather, it is possible that each of the characteristics described in one of the examples of an embodiment can be combined with one or a plurality of other desired characteristics from other embodiments, resulting in other embodiments not described in words or by reference to the drawings.

1. A method, comprising:
establishing, by a vehicle controller of a vehicle, a connection between at least one client and a plurality of servers, the plurality of servers includes a primary server and at least one replica server, the at least one replica server is a replica of the primary server;
making, by the vehicle controller, a data request about a given service to the plurality of servers;
in response to the data request, receiving reply data from the plurality of servers to the data request via a middleware;
fusing, by the vehicle controller, the reply data from the plurality of servers to generate a resulting data via the middleware;
receiving, by the vehicle controller, the resulting data; and
controlling, by the vehicle controller, the vehicle based on the resulting data.

2. The method of claim 1, further comprising generating, by the vehicle controller, a plurality of notifications by the plurality of servers in response to establishing the connection between the at least one client and the plurality of servers.

3. The method of claim 2, further comprising filtering, by the vehicle controller, duplicate notifications from the plurality of notifications generated by the plurality of servers to generate a filtered notification via the middleware.

4. The method of claim 3, further comprising receiving, by the vehicle controller, the filtered notification.

5. The method of claim 4, further comprising registering, by the vehicle controller, a same service of a plurality of services with the middleware.

6. The method of claim 5, further comprising maintaining, by the middleware, a list of instances for the same service of the plurality of services.

7. The method of claim 6, further comprising providing, by the vehicle controller, a fusion strategy to the plurality of servers.

8. The method of claim 7, further comprising providing, by the vehicle controller, a filter strategy to the plurality of servers.

9. The method of claim 8, further comprising activating, by the vehicle controller, an alarm in response to receiving the filtered notification from the middleware.

10. A system, comprising:
a vehicle including a vehicle body and a vehicle controller attached to the vehicle body, wherein the vehicle controller is programmed with a middleware to establish a connection between at least one client and a plurality of servers, the plurality of servers includes a primary server and at least one replica server;
wherein the vehicle controller is programmed to:
establish communication between at least one client and the plurality of servers;
make a data request about a service to the plurality of servers;
in response to the data request, receive reply data from the plurality of servers through the middleware;
fuse, by the middleware, the reply data from the plurality of servers to generate a resulting data; and
controlling, by the vehicle controller, the vehicle based on the resulting data.

11. The system of claim 10, wherein each of the plurality of servers generates a plurality of notifications in response to establishing the connection between the at least one client and the plurality of servers.

12. The system of claim 11, wherein the middleware filters duplicate notifications from the plurality of notifications generated by the plurality of servers to generate a filtered notification.

13. The system of claim 12, wherein the vehicle controller is programmed to receive the filtered notification.

14. The system of claim 13, wherein each of the plurality of servers registers a same service of a plurality of services with the middleware.

15. The system of claim 14, wherein the middleware maintains a list of instances for the same service of the plurality of services.

16. The system of claim 15, wherein the vehicle controller is programmed to provide a fusion strategy to the plurality of servers.

17. The system of claim 16, wherein the vehicle controller is programmed to provide a filter strategy to the plurality of servers.

18. The system of claim 17, wherein the vehicle controller is programmed to activate an alarm in response to receiving the filtered notification from the middleware.

19. A system, comprising:
a vehicle including a vehicle body and a vehicle controller attached to the vehicle body, wherein the vehicle controller is programmed with a middleware to establish a connection between at least one client and a plurality of servers;
wherein the vehicle controller is programmed to:
establish the connection between the at least one client and a plurality of servers;
make a data request about a service to the plurality of servers;
in response to the data request, receive reply data from the plurality of servers via the middleware;
fuse, by the middleware, the reply data from the plurality of servers to generate a resulting data;
receive the resulting data;
control the vehicle based on the resulting data;
wherein each of the plurality of servers generates a plurality of notifications in response to establishing the connection between the at least one client and the plurality of servers;
wherein the middleware filters duplicate notifications from the plurality of notifications generated by the plurality of servers to generate a filtered notification;
wherein the vehicle controller is programmed to receive the filtered notification;
wherein each of the plurality of servers registers a same service of a plurality of services with the middleware;
wherein the middleware maintains a list of instances for the same service of the plurality of services;
wherein the vehicle controller is programmed to provide a fusion strategy to the plurality of servers;
wherein the vehicle controller is programmed to provide a filter strategy to the plurality of servers; and
wherein the vehicle controller is programmed to activate an alarm in response to receiving the filtered notification from the middleware.
